(19) United States
(12) Patent Application Publication
(10) Pub. No.: US 2007/0063949 A1
(43) Pub. Date: Mar. 22, 2007

(54) DRIVING CIRCUIT, ELECTRO-OPTIC DEVICE, AND ELECTRONIC DEVICE

(75) Inventor: Takeshi NOMURA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/531,802

(22) Filed: Sep. 14, 2006

(30) Foreign Application Priority Data
Sep. 20, 2005 (JP) 2005-271887

(51) Int. Cl. G09G 3/36

(52) U.S. Cl. 345/89

(57) ABSTRACT

A driving circuit that drives a data line of an electro-optic device includes: a plurality of grayscale signal lines supplied with grayscale voltages, respectively; a voltage-selecting circuit that selects one grayscale voltage from the plurality of grayscale voltages supplied to the plurality of grayscale signal lines; an operational amplifier that drives, based on the grayscale voltage selected by the voltage-selecting circuit, an output line connected to the data line; and first and second resistance circuits that generate a plurality of grayscale voltages obtained by dividing a voltage between a high potential-side power source and a low potential-side power source. The first resistance circuit has a total resistance value smaller than a total resistance value of the second resistance circuit. Each of the plurality of grayscale voltages divided by the first resistance circuit is supplied, during a first period, to each of the grayscale signal lines. Each of the plurality of grayscale voltages divided by the second resistance circuit is supplied, during a second period after the first period, to each of the grayscale signal lines and the operational amplifier drives the output line based on the grayscale voltage selected from the plurality of grayscale voltages.

### BACKGROUND OF THE INVENTION

Japanese Patent Application No. 2005-271887 filed on Sep. 20, 2005, is hereby incorporated by reference in its entirety.

1. Technical Field

The present invention relates to a driving circuit, an electro-optic device, and an electronic device.

2. Related Art

Conventionally-known liquid crystal panels (electro-optic devices) used for electronic devices such as a cellular telephone include the simple matrix-type liquid crystal panel and the active matrix-type liquid crystal panel using a switching element such as a thin film transistor (hereinafter simply referred to as TFT).

The simple matrix-type liquid crystal panel is advantageous in that it reduces power consumption with a relative ease when compared with the active matrix-type liquid crystal panel. However, the simple matrix-type liquid crystal panel is disadvantageous in that it has difficulty in displaying a multicolor image or a moving image. The active matrix-type liquid crystal panel on the other hand is advantageous in that it is suitable for displaying a multicolor image and a moving image but is disadvantageous in that it finds difficulty in providing reduced power consumption.

Recently, mobile electronic devices such as a cellular telephone have an increasing demand for the display of a multicolor image and a moving image for the purpose of providing a high-quality image. This has caused the current shift from the conventional simple matrix-type liquid crystal panel to the active matrix-type liquid crystal panel.

Generally, a driving signal for displaying an image is subjected to gamma correction depending on the grayscale characteristic of a display. In the case of a liquid crystal apparatus for example, gamma correction is used to output, based on grayscale data for grayscale display, a grayscale voltage corrected so as to realize an optimal pixel transmission rate. Then, a data line is driven based on this grayscale voltage.

JP-A-2001-290457 is an example of related art.

When a voltage is outputted, as disclosed by the above example, that is obtained by dividing voltages in a predetermined range by a resistance element, the gamma correction can be realized by selecting, from among a plurality of voltages corrected and divided depending on the grayscale characteristic, a grayscale voltage corresponding to the grayscale data.

The plurality of voltages are generated by dividing voltages at both ends of a resistance element. Thus, a resistance value of the resistance element is set to be high for the purpose of reducing current flowing in the resistance element. However, levels of the respective grayscale voltages must be changed depending on the grayscale characteristic in the case of a polarity reversal driving or a multiplex driving method where a data line is driven by the time sharing depending on the respective R, G, and B color components. Thus, a high resistance value of the resistance element increases a time constant, which prolongs charge and discharge periods of the respective grayscale signal lines to which the respective grayscale voltage are supplied. In this case, a voltage of a grayscale signal line cannot be set at a desired voltage level within a predetermined time. This prevents a grayscale voltage from being generated accurately.

### SUMMARY

An advantage of the invention is to provide a driving circuit, an electro-optic device, and an electronic device by which power consumption can be reduced and a grayscale voltage can be set in a fast and accurate manner.

According to an aspect of the invention, a driving circuit includes: a plurality of grayscale signal lines supplied with grayscale voltages, respectively; a voltage-selecting circuit that selects one grayscale voltage from the plurality of grayscale voltages supplied to the plurality of grayscale signal lines; an operational amplifier that drives, based on the grayscale voltage selected by the voltage-selecting circuit, an output line connected to the data line; and first and second resistance circuits that generate a plurality of grayscale voltages obtained by dividing a voltage between a high potential-side power source and a low potential-side power source. The first resistance circuit has a total resistance value smaller than a total resistance value of the second resistance circuit. The respective plurality of grayscale voltages divided by the first resistance circuit are supplied, during a first period, to the respective grayscale signal lines. The respective plurality of grayscale voltages divided by the second resistance circuit are supplied, during a second period after the first period, to the respective grayscale signal lines and the operational amplifier drives the output line based on the grayscale voltage selected from the plurality of grayscale voltages.

In the invention, during the first period, a grayscale voltage generated by the first resistance circuit having a small total resistance value is supplied to a plurality of grayscale signal lines. Thus, the electric charge of the grayscale signal line can be charged and discharged with a small time constant. Thus, when the potential of the grayscale signal line is changed as in a polarity reversal driving or a multiplex driving in which a data line is driven with a time sharing for the respective R, G, and B color components, the charge and discharge periods of the electric charge of the grayscale signal line are increased, thus preventing a situation where the level of the grayscale voltage cannot be set to at a desired level within a driving period to prevent an accurate generation of the grayscale voltage. At a timing at which the second period is started, the potential of the potential of the grayscale voltage is already stabilized, thus allowing an operational amplifier to immediately supply a desired driving voltage to an output line. Thus, the time during which the operational amplifier operates can be reduced by the time reduced by the immediate supply of the desired driving voltage to the data line, thus reducing current consumption.

In the driving circuit according to the invention, during the first switching period including a timing at which the first period is switched to the second period, the respective plurality of grayscale voltages divided by the first resistance circuit can be supplied to the respective grayscale signal lines and the respective plurality of grayscale voltages divided by the second resistance circuit can be supplied to the respective grayscale signal lines.

According to the invention even in the case of the same grayscale voltage or different voltage levels, a situation can be avoided where, when the first period is switched to the second period, the potential of the grayscale signal line is closer to the potential of the switched period due to the capacity coupling, thus stabilizing the potential of the grayscale signal line.

In the driving circuit according to the invention, the driving circuit can include a third resistance circuit that generates a plurality of grayscale voltages obtained by dividing a voltage between the high potential-side power source and the low potential-side power source, an output of the operational amplifier can be set to be in a high impedance status during a third period after the second period and the respective plurality of grayscale voltages divided by the third resistance circuit can be supplied to the respective grayscale signal lines and the grayscale voltage selected from the plurality of grayscale voltages can be supplied to the output line.

According to the invention, the third resistance circuit is further provided. A grayscale voltage after the driving by the operational amplifier can be directly outputted to an output line to adjust the offset of the operational amplifier.

In the driving circuit according to the invention, the third resistance circuit may have a total resistance value that is larger than a total resistance value of the first resistance circuit and that is smaller than a total resistance value of the second resistance circuit.

According to the invention, during the third period, a voltage of the data line can be accurately set within a short time.

In the driving circuit according to the invention, an operation current of the operational amplifier can be stopped or limited during the third period.

According to the invention, the operation current of the operational amplifier can be stopped or limited to set the output of the operational amplifier to be in a high impedance status. Thus, an accurate voltage supply and reduced power consumption can be both realized.

In the driving circuit according to the invention, during the second switching period when the second period is switched to the third period, the respective plurality of grayscale voltages divided by the second resistance circuit can be supplied to the respective grayscale signal lines and the respective plurality of grayscale voltages divided by the third resistance circuit can be supplied to the respective grayscale signal lines.

According to the invention, even in the case of the same grayscale voltage or different voltage levels, a situation can be avoided where, when the second period is switched to the third period, the potential of the grayscale signal line is closer to the potential of the switched period due to the capacity coupling, thus stabilizing the potential of the grayscale signal line.

In the driving circuit according to the invention, at least one of the first resistance circuit and the third resistance circuit may include: a high potential side resistance value-adjusting resistance circuit having a plurality of divided nodes in which one end is connected to the high potential-side power source and from which voltages obtained by dividing voltages at both ends are outputted; a low potential side resistance value-adjusting resistance circuit having a plurality of divided nodes in which one end is connected to the low potential-side power source and from which voltages obtained by dividing voltages at both ends are outputted; and a plurality of grayscale step-adjusting resistance circuits serially connected between one divided node of the high potential side resistance value-adjusting resistance circuit and one divided node of the low potential side resistance value-adjusting resistance circuit, the respective plurality of grayscale step-adjusting resistance circuits may have a plurality of grayscale voltage output nodes from which voltages obtained by dividing voltages at both ends by a variable resistance are outputted, and voltages of the respective plurality of grayscale voltage output nodes may be outputted as the respective grayscale voltages.

According to the invention, in addition to the above-described effects, the gamma characteristic can be flexibly changed and a desired grayscale voltage can be minutely set.

The invention also relates to an electro-optic device, including: a plurality of scanning lines; a plurality of data lines; a plurality of pixels; a scanning line driving circuit that scans the plurality of scanning lines; and the driving circuit according to any of the above ones that drives the plurality of data lines.

According to the invention, an electro-optic device including a driving circuit that consumes less power and that can set a grayscale voltage in a fast and accurate manner can be provided.

The invention also relates to an electronic device that includes the electro-optic device according to the above description.

The invention can provide an electronic device using an electro-optic device including a driving circuit that provides low power consumption and that can set a grayscale voltage in a fast and accurate manner.

### BRIEF DESCRIPTION OF THE DRAWINGS

The invention will be described with reference to the accompanying drawings wherein like numbers reference like elements.

FIG. 1 is a schematic view illustrating the structure of a liquid crystal display of this embodiment.

FIG. 2 is a schematic view illustrating another structure of the liquid crystal display in this embodiment.

FIG. 3 illustrates the structure of a gate driver of FIG. 1.

FIG. 4 is a block diagram illustrating an example of the structure of a data driver of FIG. 1.

FIG. 5 is a circuit diagram illustrating an example of the structure of a grayscale voltage-generating circuit, a DAC, and a driving section of FIG. 4.

FIG. 6 is a circuit diagram illustrating an example of the structure of the first resistance circuit.

FIG. 7 is a schematic diagram illustrating the structure of a gamma control signal-generating circuit.

FIG. 8 illustrates a gamma characteristic.

FIG. 9A shows an example of the structure illustrating a voltage-selecting circuit.

FIG. 9B shows an example of the structure illustrating a voltage-selecting circuit.

FIG. 10 is a schematic view illustrating an example of a voltage change of a data line in this embodiment.

FIG. 11 is a timing diagram illustrating an example of the control of the data driver of this embodiment.

FIG. 12 is a timing diagram illustrating another example of the data driver of this embodiment.

FIG. 13 is a block diagram illustrating an example of the structure of an electronic device in this embodiment.

### DESCRIPTION OF EXEMPLARY EMBODIMENTS

Embodiments of the invention will now be described in detail with reference to the drawings. It is noted that embodiments described below do not inappropriately limit the contents of the invention described in the claims. It is also noted that all configurations used in the following description are not always required in the invention.

1. Liquid Crystal Display

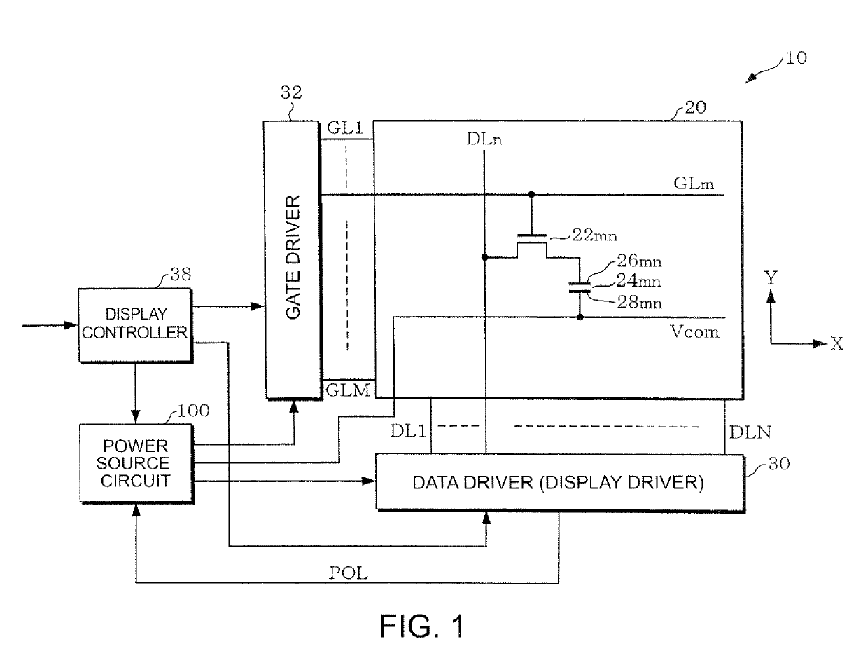

FIG. 1 is a schematic view illustrating the structure of an active matrix-type liquid crystal display in this embodiment. The following section will describe the active matrix-type liquid crystal display. However, a data driver in this embodiment (display driver and driving circuit in the wider sense) also can be used in a simple matrix-type liquid crystal display.

A liquid crystal display 10 includes: a liquid crystal display (LCD) panel (display panel in the wider sense and electro-optic device in the further wider sense) 20. The LCD panel 20 is formed on a glass substrate for example. This glass substrate has thereon scanning lines (gate lines) CL1 to GLM (M is an integer equal to or higher than 2) that are arranged in a plurality of rows in a direction Y and that extend in a direction X, respectively and data lines (source lines) DL1 to DLN (N is an integer equal to or higher than 2) that are arranged in a plurality of rows in the direction X and that extend in the direction Y, respectively. A pixel region (pixel) is provided to correspond to a position at which a scanning line GLm (1≦m≦M, “m” represents an integer in the following description) and a data line DLn (1≦n≦M, “n” represents an integer in the following description) intersect. The pixel region has thereon a TFT 22mn.

A gate of the TFT 22mn is connected to a scanning line GLn. A source of the TFT 22mn is connected to the data line DLn. A drain of the TFT 22mn is connected to a pixel electrode 26mn. Liquid crystal is filled into a space between a pixel electrode 26mn and an opposing electrode 28mn opposed to the pixel electrode 26mn to form a liquid crystal capacity (liquid crystal element in the wider sense) 24mn. In this structure, a pixel transmission rate is changed in accordance with a voltage applied between the pixel electrode 26mn and the opposing electrode 28mn. An opposing electrode voltage Vcom is supplied to the opposing electrode 28mn.

The LCD panel 20 having the structure as described above is provided, for example, by adhering the first substrate including a pixel electrode and a TFT with the second substrate including an opposing electrode to fill liquid crystal as electrooptic material into a space between the substrates.

The liquid crystal display 10 includes a data driver (display driver in the wider sense and driving circuit in the further wider sense) 30. The data driver 30 drives the data lines DL1 to DLN of the LCD panel 20 based on grayscale data.

The liquid crystal display 10 can include a gate driver (scanning driver or scanning line driving circuit in the wider sense) 32. The gate driver 32 scans scanning lines GL1 to GLM of the LCD panel 20 within a one vertical scanning period.

The liquid crystal display 10 can include a power source circuit 100. The power source circuit 100 generates voltages required for driving a data line and supplies the voltages to the data driver 30. The power source circuit 100 generates, for example, a voltage VDDH or VSSH required for driving a data line by the data driver 30 or a voltage for a logic section of the data driver 30.

The power source circuit 100 generates a voltage required for scanning a scanning line to supply the voltage to the gate driver 32.

The power source circuit 100 also generates an opposing electrode voltage Vcom. The power source circuit 100 outputs, to an opposing electrode of the LCD panel 20, the opposing electrode voltage Vcom that cyclically repeats a high potential-side voltage VCOMH and a low potential-side voltage VCOML in accordance with a timing at which a polarity reversal signal POL is generated by the data driver 30.

The liquid crystal display 10 can include a display controller 38. The display controller 38 controls, based on the contents set by a host (not shown) such as a central processing unit (hereinafter simply referred to as CPU), the data driver 30, the gate driver 32, and the power source circuit 100. For example, the display controller 38 sets an operation mode of the data driver 30 and the gate driver 32 or supplies, to the data driver 30 and the gate driver 32, a vertical synchronization signal or a horizontal synchronization signal generated therein. In this embodiment, the display controller 38 supplies gamma correction data to the data driver 30 to realize various gamma corrections.

Although FIG. 1 shows a structure in which the liquid crystal display 10 includes the power source circuit 100 or the display controller 38, another structure also may be used in which at least one of them is provided outside the liquid crystal display 10. Alternatively, another structure also may be used in which the liquid crystal display 10 also includes a host.

The data driver 30 also may include at least one of the gate driver 32 and the power source circuit 100.

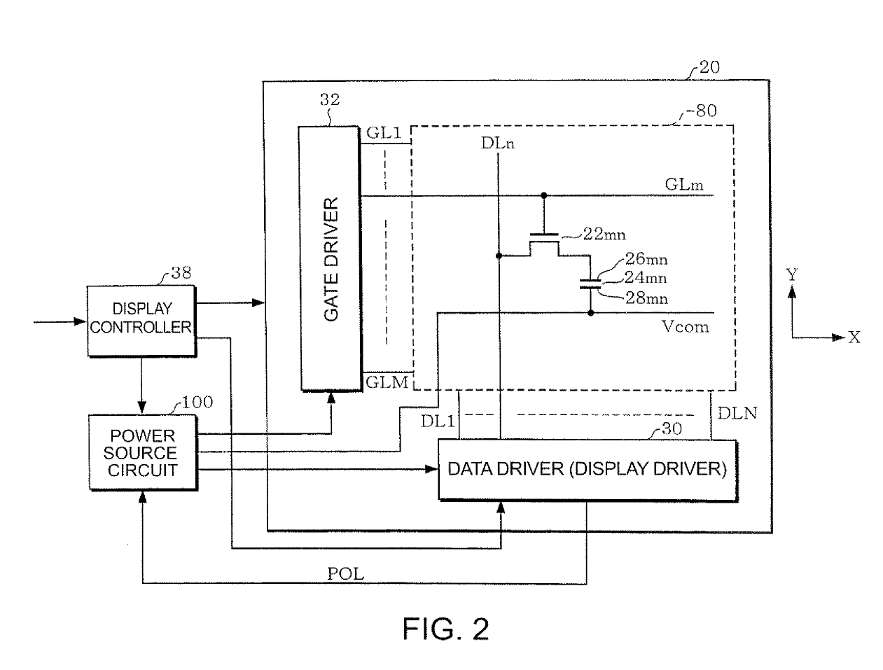

Alternatively, the data driver 30, the gate driver 32, the display controller 38, and the power source circuit 100 also may be partially or entirely provided on the LCD panel 20. For example, FIG. 2 shows the data driver 30 and the gate driver 32 formed on the LCD panel 20. As described above, the LCD panel 20 can be structured to include: a plurality of data lines; a plurality of scanning lines; a plurality of switch elements connected to the respective plurality of scanning lines and the respective plurality of data lines; and a display driver for driving the plurality of data lines. In a pixel formation region 80 of the LCD panel 20, a plurality of pixels are formed.

2. Gate Driver

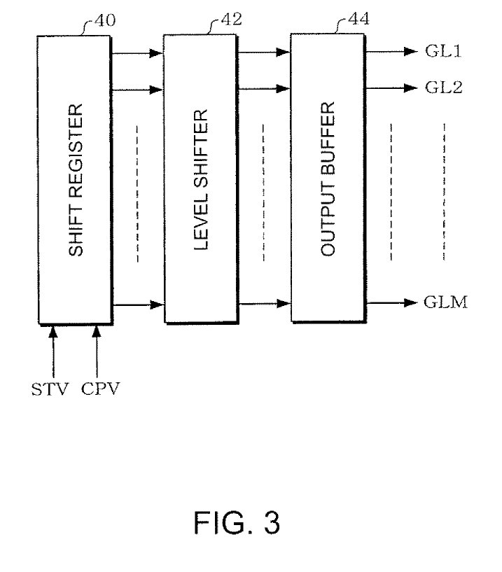

FIG. 3 illustrates an example of the structure of the gate driver 32 of FIG. 1.

The gate driver 32 includes a shift register 40, a level shifter 42, and an output buffer 44.

The shift register 40 includes a plurality of flip-flops that are provided to correspond to the respective scanning lines and that are sequentially connected. When this shift register 40 maintains a start pulse signal STV at flip-flop in synchronization with a clock signal CPV, then the shift register 40 is sequentially synchronized with the clock signal CPV to shift the start pulse signal STV to a neighboring flip-flop. Here, the inputted clock signal CPV is a horizontal synchronization signal and the start pulse signal STV is a vertical synchronization signal.

The level shifter 42 shifts a level of a voltage from the shift register 40 to a voltage level depending on a liquid crystal element of the LCD panel 20 and a TFT transistor capability. This voltage level must be, for example, a high voltage level from 20V to 50V.

The output buffer 44 buffers the scanning voltage shifted by the level shifter 42 and outputs the scanning voltage to a scanning line to drive the scanning line.

3. Data Driver (Driving Circuit)

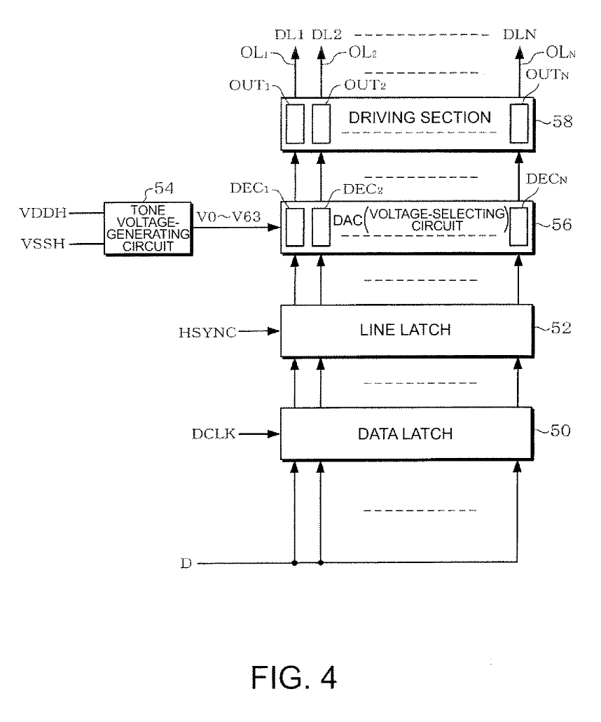

FIG. 4 is a block diagram illustrating an example of the structure of the data driver 30 of FIG. 1. Although FIG. 4 illustrates the structure based on an assumption that the bit number of grayscale data per one dot is 6, the invention is not limited to the bit number of grayscale data.

The data driver 30 includes: a data latch 50; a line latch 52; a grayscale voltage-generating circuit 54: a digital/analog converter (DAC) 56; and a driving section 58.

The data driver 30 is serially inputted with grayscale data on the basis of a pixel unit (or a one dot unit). This grayscale data is inputted in synchronization with a dot clock signal DCLK. The dot clock signal DCLK is supplied from the display controller 38.

The data latch 50 includes a plurality of resisters each of which retains grayscale data for one dot. The data latch 50 can acquire grayscale data for one horizontal scanning for example.

The line latch 52 latches the grayscale data of one horizontal scanning latched by the data latch 50 with a timing at which a horizontal synchronization signal HSYNC changes. The line latch 52 also includes a plurality of resisters each of which retains grayscale data for one dot. Each of the plurality of resisters of the line latch 52 acquires grayscale data retained by each of the plurality of resisters of the data latch 50.

The grayscale voltage-generating, circuit 54 generates a plurality of grayscale voltages each of which corresponds to each piece of grayscale data. More specifically, the grayscale voltage-generating circuit 54 generates, based on a voltage VDDH of a high potential-side power source and a voltage VSSH of a low potential-side power source, a plurality of grayscale voltages V0 to V63 each of which corresponds to each piece of grayscale data of 6 bits. The grayscale voltage-generating circuit 54 as described above outputs, as a grayscale voltage, voltages of a plurality of divided nodes of a resistance circuit in which the voltage VDDH and the voltage VSSH are supplied to both ends thereof, respectively.

The DAC 56 generates, for the respective output lines as an output of the driving section 58, the grayscale voltages corresponding to grayscale data outputted from the line latch 52. The respective output lines are electrically connected to the respective data lines of the LCD panel 20. More specifically, the DAC 56 selects, from among a plurality of grayscale voltages V0 to V63 generated by the grayscale voltage-generating circuit 54, a grayscale voltage corresponding to grayscale data for one output line of the driving section 58 outputted from the line latch 52 to output the selected grayscale voltage.

The DAC 56 includes voltage-selecting circuits DEC₁ to DEC_{N} provided for the respective output lines. The respective voltage-selecting circuits output, from among grayscale voltages V0 to V63, one grayscale voltage corresponding to the grayscale data.

In the driving section 58, the respective output lines drive a plurality of output lines connected to the respective data lines of the LCD panel 20. More specifically, the driving section 58 drives the respective output lines based on grayscale voltages for the respective output lines outputted from the voltage-selecting circuit of the DAC 56. The driving section 58 includes output circuits OUT₁ to OUT_{N} provided for the respective output lines. The respective output circuits drive data lines based on grayscale voltages from the respective voltage-selecting circuits. Each output circuit can be composed of an operational amplifier connected by a voltage follower.

4. Structure of the Main Part of a Data Driver

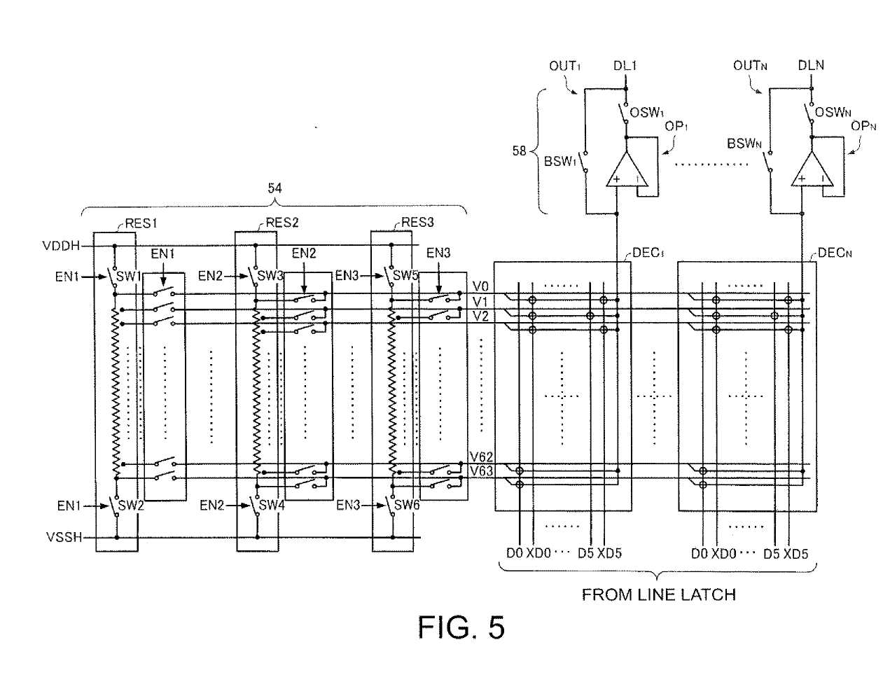

FIG. 5 is a circuit diagram illustrating an example of the structure of the grayscale voltage-generating circuit 54, the DAC 56, and the driving section 58 of FIG. 4. It is noted that this embodiment does not require all circuit blocks shown in FIG. 5.

The grayscale voltage-generating circuit 54 can include the first to the third resistance circuits RES1 to RES3. The first to the third resistance circuits RES1 to RES3 are structured so that both ends of each of the first to the third resistance circuits RES1 to RES3 are connected with a high potential-side power source and a low potential-side power source.

Specifically, both ends of the first resistance circuit REST are connected with one ends of switch elements SW1 and SW2, respectively. The other end of the switch element SW1 is connected with a high potential-side power source and the other end of the switch element SW2 is connected with a low potential-side power source. The switch elements SW1 and SW2 are subjected to a switch control (ON/OFF control) by an enable signal EN1. Specifically, when the enable signal EN1 is active, the switch elements SW1 and SW2 are in a conducting status. When the enable signal EN1 is inactive, the switch elements SW1 and SW2 are in a non-conducting status.

Both ends of the second resistance circuit RES2 are connected with one ends of switch elements SW3 and SW4, respectively. The other end of the switch element SW3 is connected with a high potential-side power source and the other end of the switch element SW4 is connected with a low potential-side power source. The switch elements SW3 and SW4 are subjected to a switch control (ON/OFF control) by the enable signal EN2. Specifically, when the enable signal EN2 is active, the switch elements SW3 and SW4 are in a conducting status. When the enable signal EN2 is inactive, the switch elements SW3 and SW4 are in a non-conducting status.

Both ends of the third resistance circuit RES3 are connected with one ends of switch elements SW5 and SW6, respectively. The other end of the switch element SW5 is connected with a high potential-side power source and the other end of the switch element SW6 is connected with a low potential-side power source. The switch elements SW5 and SW6 are subjected to a switch control (ON/OFF control) by an enable signal EN3. Specifically, when the enable signal EN3 is active, the switch elements SW5 and SW6 are in a conducting status. When the enable signal EN3 is inactive, the switch elements SW5 and SW6 are in a non-conducting status.

The first to third resistance circuits RES1 to RES3 as described above can generate a plurality of voltages as grayscale voltages V0 to V63 obtained by dividing voltages at both ends thereof.

The first resistance circuit RES1 has a total resistance value r1 that is smaller than a total resistance value r2 of the second resistance circuit RES2. The third resistance circuit RES3 has a total resistance value r3 that is larger than the total resistance value r1 of the first resistance circuit RES1 and that is smaller than the total resistance value r2 of the second resistance circuit RES2. Specifically, a relation of r1<r3<r2 is established. The total resistance value r3 smaller than the total resistance value r2 allows a voltage of a data line to be set within a short time. While the relation of r1<r3<r2 being established, a single resistance splitting ratio is used in order that the respective first to third resistance circuits RES1 to RES3 generate a plurality of voltages.

The first to third resistance circuits RES1 to RES3 also may be provided so that both ends of each of them are connected with power sources different from the above high potential-side power source and low potential-side power source.

The respective grayscale voltages V0 to V63 generated by the first to third resistance circuits RES1 to RES3 are supplied to the respective grayscale signal lines GS1 to GS64. Thus, the grayscale voltage-generating circuit 54 includes the first to third output selection circuits OSEL1 to OSEL3 so that the grayscale voltages V0 to V63 generated by the respective first to third resistance circuits RES1 to RES3 are outputted to the grayscale signal lines GS1 to GS64.

The first output selection circuit OSEL1 includes sixty four switch elements for outputting the respective grayscale voltages V0 to VS63 (the first grayscale voltage group) generated by the first resistance circuit RES1 to the respective grayscale signal lines GS1 to GS64. These switch elements are simultaneously ON/OFF-controlled by an enable signal EN1. The second output selection circuit OSEL2 includes sixty four switch elements for outputting the respective grayscale voltages V0 to V63 (the second grayscale voltage group) generated by the second resistance circuit RES2 to the respective grayscale signal lines GS1 to GS64. These switch elements are simultaneously ON/OFF-controlled by an enable signal EN2. The third output selection circuit OSEL3 includes sixty four switch elements for outputting the respective grayscale voltages V0 to V63 (the third grayscale voltage group) generated by the third resistance circuit RES3 to the respective grayscale signal lines GS1 to GS64. These switch element are simultaneously ON/OFF-controlled by an enable signal EN3.

The grayscale signal lines GS1 to GS64 are commonly connected to the voltage-selecting circuits DEC₁ to DEC_{N} of the DAC 56. The voltage-selecting circuits DEC₁ to DEC_{N} have a single structure respectively. The respective voltage-selecting circuits are inputted with grayscale data D0 to DS (each of which is 6 bit) from the line latch 52 and invert data XD0 to XD5 respectively having 6 bits. Then, in accordance with the grayscale data D0 to D5 and the invert data XD0 to XD5, one of the grayscale voltages V0 to V63 is outputted to the respective output circuits. A voltage-selecting circuit DECⱼ (1≦j≦N, “j” is an integer) receives grayscaler data from the line latch 52 to supply the grayscaler data to an output circuit OUTⱼ. The one grayscale voltage selected by the voltage-selecting circuit DECⱼ from among the grayscale voltages V0 to V63 is outputted to the output circuit OUTⱼ.

The output circuit OUTⱼ includes an operational amplifier OPⱼ, an output switch OSWⱼ, and a bypass switch BSWⱼ. The operational amplifier OPⱼ is connected to a voltage follower and is inputted with a grayscale voltage selected by the voltage-selecting circuit DECⱼ. The output switch OSWⱼ is inserted between an input of the operational amplifier OPⱼ and the output line Olⱼ connected with the data line DLj. The bypass switch BSWⱼ is inserted between an input of the operational amplifier OPⱼ and the output line Olⱼ.

In FIG. 5, at least two of the first to third resistance circuits RES1 to RES3 can have the same structure. At leasgrayscale of the first to third resistance circuits RES1 to RES3 can have the structure as shown below.

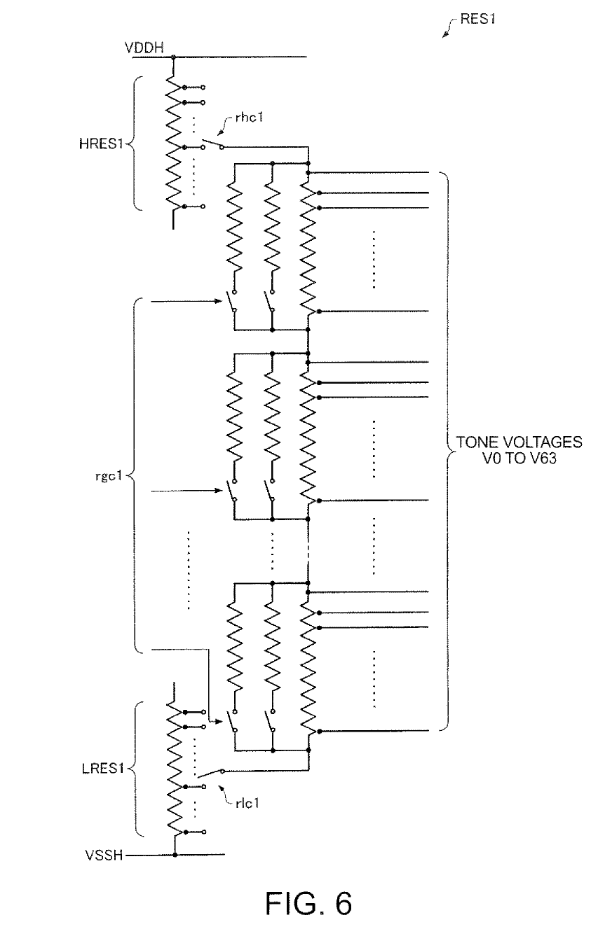

FIG. 6 is a circuit diagram illustrating an example of the structure of the first resistance circuit RES1.

The first resistance circuit RES1 includes: a high potential side resistance value-adjusting resistance circuit HRES1; a low potential side resistance value-adjusting resistance circuit LRES1; and a plurality of serially connected grayscale step-adjusting resistance circuits.

One end of the high potential side resistance value-adjusting resistance circuit HRES1 is connected with a high potential-side power source. The high potential side resistance value-adjusting resistance circuit HRES1 has a plurality of divided nodes for outputting voltages obtained by dividing voltages at both ends thereof. One end of the low potential side resistance value-adjusting resistance circuit LRES1 is connected with a low potential-side power source. The low potential side resistance value-adjusting resistance circuit LRES1 has a plurality of divided nodes for outputting voltages obtained by dividing voltages at both ends thereof. The plurality of grayscale step-adjusting resistance circuits are connected between one divided node of the high potential side resistance value-adjusting resistance circuit HRES1 and one divided node of the low potential side resistance value-adjusting resistance circuit LRES1. The respective grayscale step-adjusting resistance circuits have a plurality of grayscale voltage output nodes for outputting voltages obtained by dividing voltages at both ends by a variable resistance. A voltage of the grayscale voltage output node is outputted as a grayscale voltage.

One of the plurality of divided nodes of the high potential side resistance value-adjusting resistance circuit HRES1 is selected by a control signal rhc1. Then, the divided node selected by the control signal rhc1 is electrically connected with or blocked from, by the control signal rhc1, one end of the plurality of grayscale step-adjusting resistance circuits.

One of the plurality of divided nodes of the low potential side resistance value-adjusting resistance circuits LRES1 is selected by the control signal rlc1. Then, the divided node selected by the control signal rlc1 is electrically connected with or blocked from, by the control signal rlc1, the other end of the plurality of grayscale step-adjusting resistance circuits.

Voltages at both ends of the respective plurality of grayscale step-adjusting resistance circuits are variable-controlled by the control signal rgc1. For example, the respective grayscale step-adjusting resistance circuits include a fixed resistance element having a fixed resistance value and one or a plurality of variable resistance element(s) connected in parallel with the fixed resistance element. A switch element connected to the variable resistance element(s) is switch-controlled by the control signal rgc1.

The control signals rhc1, rlc1, and rgc1 as described above are generated by a gamma control signal-generating circuit as described below.

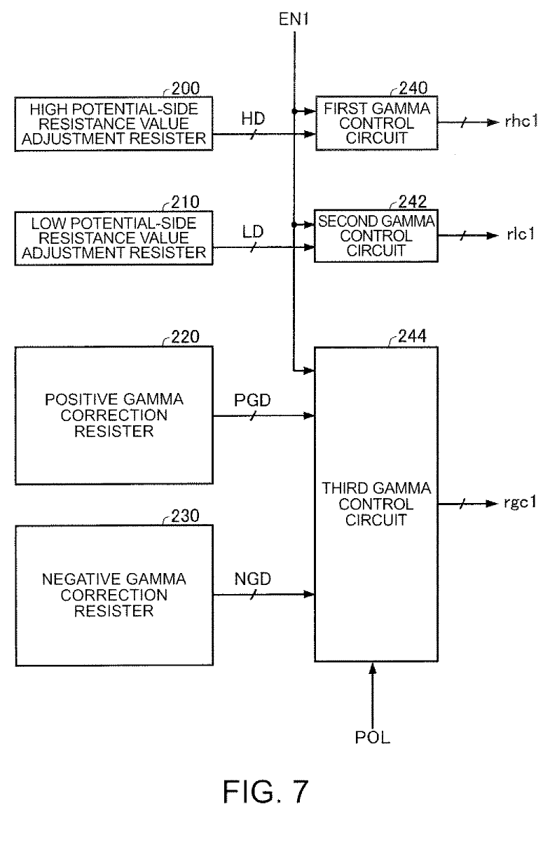

FIG. 7 illustrates the outline of the gamma control signal-generating circuit.

The data driver 30 includes the gamma control signal-generating circuit of FIG. 7. The control signals rhc1, rlc1, and rgc1 generated by the gamma control signal-generating circuit are outputted to the grayscale voltage-generating circuit 54.

The gamma control signal-generating circuit can include: a high potential-side resistance value adjustment resister 200; a low potential-side resistance value adjustment resister 210; a positive gamma correction resister 220; a negative gamma correction resister 230; and the first to third gamma control circuits 240, 242, and 244.

The high potential-side resistance value adjustment resister 200 is set with high potential-side resistance value adjustment data HD by the display controller 38 or a host (not shown). The high potential-side resistance value adjustment data HD is data for specifying one of a plurality of divided nodes of the high potential side resistance value-adjusting resistance circuit HRES1. The first gamma control circuit 240 generates the control signal rhc1 based on the enable signal EN1 and the high potential-side resistance value adjustment data HD. When the enable signal EN1 is active, the control signal rhc1 is generated such that any one of a plurality of divided nodes of high potential side resistance value-adjusting resistance circuit HRES1 selected by the high potential-side resistance value adjustment data HD is electrically connected with one end of a plurality of grayscale step-adjusting resistance circuits.

The low potential-side resistance value adjustment resister 210 is set with the low potential-side resistance value adjustment data LD by the display controller 38 or a host (not shown). The low potential-side resistance value adjustment data LD is data for specifying one of a plurality of divided nodes of the low potential side resistance value-adjusting resistance circuit LRES1. The second gamma control circuit 242 generates the control signal rlc1 based on the enable signal EN2 and the low potential-side resistance value adjustment data LD. When the enable signal EN1 is active, the control signal rlc1 is generated such that any one of a plurality of divided nodes of the low potential side resistance value-adjusting resistance circuit LRES1 selected by the low potential-side resistance value adjustment data LD is electrically connected with the other end of a plurality of grayscale step-adjusting resistance circuits.

The positive gamma correction resister 220 is set with positive gamma correction data PGD by the display controller 38 or a host (not shown). The positive gamma correction data PGD is data for setting the respective grayscale voltages V0 to V63 in a positive period during which a voltage applied to liquid crystal in a polarity reversal driving performed in synchronization with the polarity reversal signal POL is positive. More specifically, the positive gamma correction data PGD is data for setting voltages at both ends of the respective grayscale step-adjusting resistance circuits during the positive period. The third gamma control circuit 244 generates the control signal rgc1 based on the positive gamma correction data PGD, the negative gamma correction data NGD, the enable signal EN1, and the polarity reversal signal POL. When the enable signal EN1 is active and the positive period is specified by the polarity reversal signal POL, the control signal rgc1 is generated such that a voltage corresponding to the positive gamma correction data PGD is generated as the grayscale voltages V0 to V63.

The negative gamma correction resister 230 is set with the negative gamma correction data NGD by the display controller 38 or a host (not shown). The negative gamma correction data NGD is data for setting the respective grayscale voltages V0 to V63 in a negative period during which a voltage applied to liquid crystal is negative in a polarity reversal driving performed in synchronization with the polarity reversal signal POL. More specifically, the negative gamma correction data NGD is data for setting voltages at both ends of the respective grayscale step-adjusting resistance circuits during the negative period. When the enable signal EN1 is active and a negative period is specified by the polarity reversal signal POL, the control signal rgc1 is generated such that a voltage corresponding to the negative gamma correction data NGD is generated as the grayscale voltages V0 to VG3.

A gamma characteristic can be changed by using different grayscale voltages V0 to V63 based on the data set for the high potential-side resistance value adjustment resister 200, the low potential-side resistance value adjustment resister 210, the positive gamma correction resister 220, and the negative gamma correction resister 230.

The second to third resistance circuits RES2 and RES3 are also controlled based on the control signals rhc2, rlc2, rgc2, rhc3, rlc3, and rgc3 generated by the same gamma control signal-generating circuit as that shown in FIG. 7. In this case, each of the first to third resistance circuits RES1 to RES3 may be provided with a high potential-side resistance value adjustment resister, a low potential-side resistance value adjustment resister, a positive gamma correction resister, and a negative gamma correction resister. Aternatively, the respective first to third resistance circuits RES1 to RES3 also may commonly have a high potential-side resistance value adjustment resister, a low potential-side resistance value adjustment resister, a positive gamma correction resister, and a negative gamma correction resister.

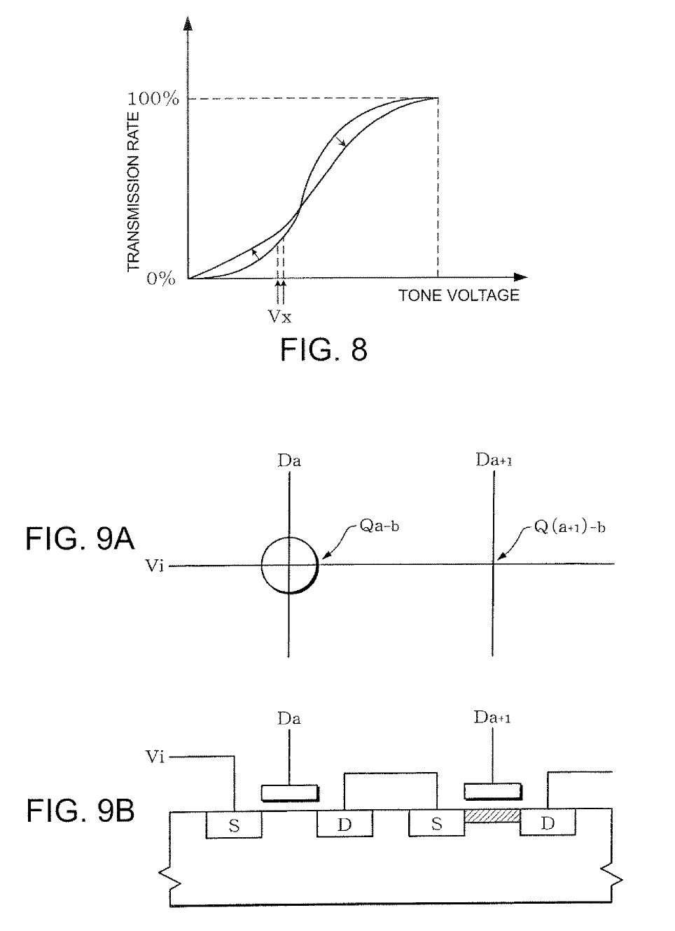

FIG. 8 is a diagram for explaining a gamma characteristic.

In FIG. 8, the horizontal axis represents a grayscale voltage and the vertical axis represents a pixel transmission rate. By changing a grayscale voltage, a transmission rate corresponding to the grayscale voltage can be changed. Thus, a manner in which the transmission rate is changed can be changed even for the same grayscale data.

FIG. 9A and FIG. 9B illustrate an example of the structure of the voltage-selecting circuit DEC₁.

FIG. 9A illustrates an example in which the voltage-selecting circuit DEC₁ is composed of a so-called Read Only Memory (ROM). In this case, as shown in FIG. 9B, a transistor Qa−b is provided at a position at which a grayscale signal line GS(i+1) supplied with the grayscale voltage Vi (0≦i≦63, “i” is an integer) intersects with a one bit data line Da of the grayscale data.

In an actual case, a transistor Q(a+1)−b is also provided at a position at which the grayscale signal line GS(i+1) intersects with a one bit data line Da+1of the grayscale data. As shown in FIG. 9B, a channel region of the transistor Q(a+1)−b is formed so as to be always in a conducting status by ion implantation. Thus, the transistor Qa−b operates as a so-called switch element and the transistor Q(a+1)−b is a switch element that is always in an ON status. As a result, an effect is provided in which ROM data can be changed only by a so-called mask exchange and a layout area can be reduced.

5. Example of Control of Data Driver

By the way, when the data driver 30 drives the LCD panel 20 by a polarity reversal driving, potentials of the respective grayscale voltages V0 to V63 during the positive period frequently differ from potentials of the respective grayscale voltages V0 to V63 during the negative period. The reason is that the gamma characteristic during the positive period is different from the gamma characteristic during the negative period and that the high potential-side power source voltage VDDH and the low potential-side power source voltage VSSH during the positive period are different from the high potential-side power source voltage VDDH and the low potential-side power source voltage VSSH during the negative period. In this case, charges of the respective grayscale signal lines GS1 to GS64 must he charged and discharged at a timing at which the polarity of the polarity reversal driving is switched.

However, a resistance circuit that is inserted between a high potential-side power source and a low potential-side power source to divide voltages at both ends thereof is set with a high resistance value in order to reduce current flowing in the resistance circuit as much as possible. In this case, a time constant is increased and a time required for charging or discharging the electric charge of a grayscale signal line is increased. Thus, the grayscale voltage cannot be set at a desired level within a driving period and thus the grayscale voltage cannot be generated accurately.

Thus, in this embodiment, a grayscale voltage for driving a data line by an operational amplifier is generated by the second resistance circuit RES2 and the first resistance circuit RES1 is provided that has a total resistance value smaller than the total resistance value of the second resistance circuit RES2. Thus, prior to the driving by the operational amplifier, the first resistance circuit RES1 is used to charge and discharge the electric charge of the grayscale signal lines GS1 to GS64. As a result, a small time constant can be used to charge and discharge the electric charge of the grayscale signal lines and current flowing in the resistance circuit can be reduced in a period during which the driving by the operational amplifier is performed. Thus, the data driver 30 can be provided that consumes less power and that can set a grayscale voltage in a fast and accurate manner.

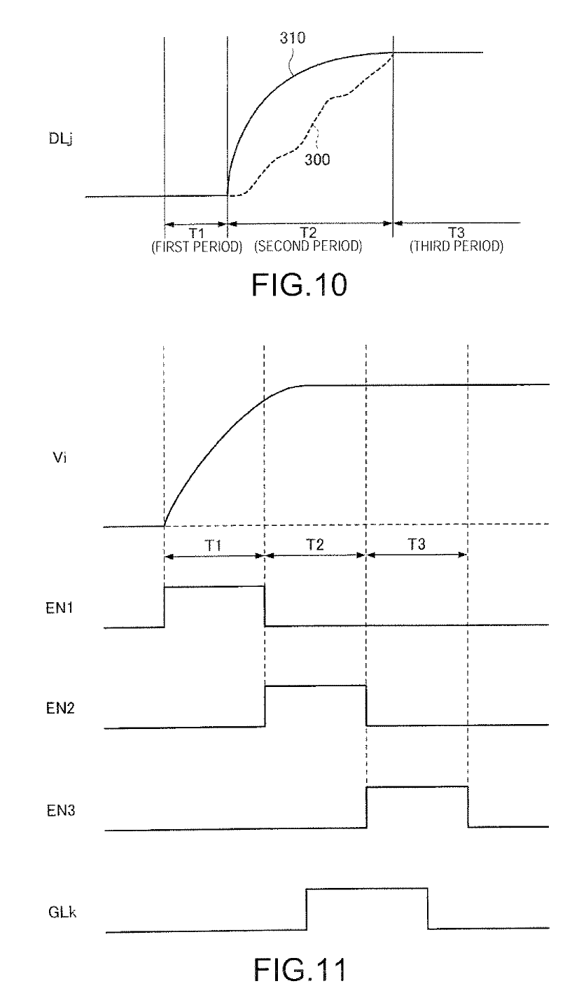

FIG. 10 is a schematic view illustrating the voltage change of the data line DLj driven by the data driver 30 of this embodiment.

In this embodiment, the grayscale signal lines GS1 to GS64 are pre-charged during the first period T1 prior to the second period T2 which is a driving period of the operational amplifier OPⱼ. During this the first period T1, the grayscale voltages V0 to V63 generated by the first resistance circuit RES1 having a small total resistance value are generated. Thus, the potentials of the grayscale signal lines GS1 to GS64 are fixed within a shorter period.

Thereafter, the operational amplifier OPⱼ drives the data line DLj during the second period T2 based on one grayscale voltage of the grayscale voltages V0 to V63 of the grayscale signal lines GS1 to GS64 pre-charged within the first period T1. Even after a timing at which the second period T2 is started and when the potentials of the grayscale voltages V0 to V63 are unstable, the operational amplifier OPⱼ requires a longer time for supplying a desired driving voltage to the data line DLj as shown by the voltage change 300 of FIG. 10.

In contrast with this, this embodiment already stabilizes the potentials of the grayscale voltages V0 to V63 at a timing at which the second period T2 is started. Thus, as shown by the voltage change 310 of FIG. 10, the operational amplifier OPⱼ can immediately supply a desired driving voltage to the data line DLj. Thus, the time during which the operational amplifier OPⱼ operates can be reduced by the time reduced by the immediate supply of the desired driving voltage to the data line DLj, thus reducing current consumption.

FIG. 11 is a timing diagram illustrating an example of a control of the data driver 30 of this embodiment.

FIG. 11 illustrates the change of a voltage of a grayscale signal line supplied with the grayscale voltage Vi. FIG. 11 also illustrates the change of a selected voltage of the scanning line GLk (1≦k≦M, “k” is an integer).

First, the enable signal EN1 is set to be active and the enable signal EN2 is set to be inactive (the enable signal EN3 is set to be inactive) during the first period T1 and the respective plurality of grayscale voltages divided by the first resistance circuit RES1 are supplied to the respective grayscale signal lines. Then, an operation current also may be flowed to the operational amplifier OPⱼ and the output switch OSWⱼ is set to be in a conducting status and the bypass switch BSWⱼ is set to be in a non-conducting status and any one of the grayscale voltages V0 to V63 generated within the first period T1 may be used to drive the output line Olⱼ.

Next, during the second period T2 after the first period T1, the enable signal EN1 is set to be inactive and the enable signal EN2 is set to be active (and the enable signal EN3 is set to be inactive) and the respective plurality of grayscale voltages divided by the second resistance circuit RES2 are supplied to the respective grayscale signal lines. Then, an operation current is flowed into the operational amplifier OPⱼ to set the output switch OSWⱼ to be in a conducting status and to set the bypass switch BSWⱼ to be in a non-conducting status Then, the operational amplifier OPⱼ drives the output line Olⱼ based on the grayscale voltage selected from the plurality of grayscale voltages generated during the second period T2.

Here, when the first resistance circuit RES1 has the same resistance splitting ratio as that of the second resistance circuit RES2, the respective grayscale voltages V0 to VS63 generated during the first period T1 can have an identical potential with that of the respective grayscale voltages V0 to V63 generated during the second period T2, thus realizing a fast pre-charge.

This embodiment also may further provide the third resistance circuit RES3 so that a grayscale voltage after the driving by the operational amplifier is directly outputted to an output line to adjust the offset of the operational amplifier. During this, the operation current of the operational amplifier can be stopped or limited to set the output of the operational amplifier in a high impedance status. Thus, an accurate voltage supply and reduced power consumption can be both provided.

Specifically, during the third period T3 after the second period T2, the output of the operational amplifier OPⱼ is set to be in a impedance status and the enable signals EN1 and EN2 are set to be inactive and the enable signal EN3 is set to be active. Then, the respective plurality of grayscale voltages divided by the third resistance circuit RES3 are supplied to the respective grayscale signal lines. Then, the operation current of the operational amplifier OPⱼ is stopped or limited and the output switch OSWⱼ is set to be in a non-conducting status and the bypass switch BSWⱼ is set to be in a conducting status. Then, a grayscale voltage selected from the plurality of grayscale voltages generated during the third period T3 is directly supplied to the output line OLⱼ. Specifically, the operational amplifier OPⱼ is bypassed and the grayscale voltage is directly supplied to the output line OLⱼ.

The first period T1 also may be separated from the second period T2 with a predetermined length of period. The second period T2 also may be separated from the third period T3 with a predetermined length of period.

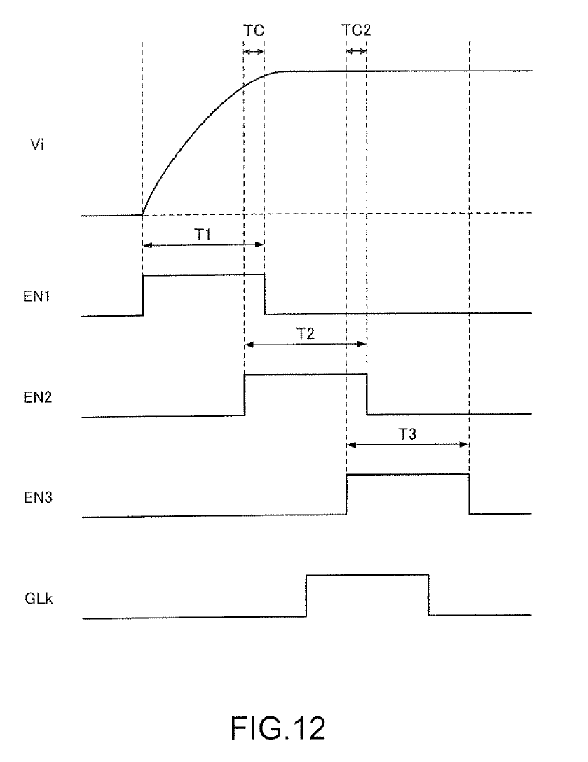

FIG. 12 is a timing diagram illustrating another example of the data driver 30 of this embodiment.

As with FIG. 11, FIG. 12 also shows the change of a voltage of a grayscale signal line supplied with the grayscale voltage Vi. FIG. 12 also shows the change of a selected voltage of the scanning line GLk.

FIG. 12 is different from FIG. 11 in that, when the first second period T1 is switched to: the second period T2, the first and the second periods T1 and T2 are overlapped. Specifically, during the first switching period TC1 including a timing at which the first period T1 is switched to the second period T2, the respective plurality of grayscale voltages divided by the first resistance circuit RES1 are supplied to the respective grayscale signal lines and the respective plurality of grayscale voltages divided by the second resistance circuit RES2 are supplied to the respective grayscale signal lines.

Thus, the enable signal EN1 is set to be active and the enable signals EN2 and EN3 are set to be inactive during the first period T1 and the respective plurality of grayscale voltages divided by the first resistance circuit RES1 are supplied to the respective grayscale signal lines. Then, an operation current is flowed into the operational amplifier OPⱼ and the output switch OSWⱼ is set to be in a conducting status and the bypass switch BSWⱼ is set to be in a non-conducting status. Then, any one of the grayscale voltages V0 to V63 generated during the first period T1 also may be used to drive the output line OLⱼ.

Then, during the first switching period TC1 including a timing at which the first period T1 is switched to the second period T2, the enable signals EN1 and EN2 are active (and the enable signal EN3 is inactive). Then, the respective plurality of grayscale voltages divided by the first resistance circuit RES1 are supplied to the respective grayscale signal lines and the respective plurality of grayscale voltages divided by the second resistance circuit RES2 are supplied to the respective grayscale signal lines.

The structure as described above can avoid, even in the case of the same grayscale voltage or different voltage levels, a situation where, when the first period T1 is switched to the second period T2, the potential of the grayscale signal line is closer to the potential of the switched period due to the capacity coupling, thus stabilizing the potential of the grayscale signal line.

FIG. 12 is also different from FIG. 11 in that the second and third periods T2 and T3 are overlapped when the second period T2 is switched to the third period T3. Specifically, during the second switching period TC2 including a timing at which the second period T2 is switched to the third period T3, the respective plurality of grayscale voltages divided by the second resistance circuit RES2 are supplied to the respective grayscale signal lines and the respective plurality of grayscale voltages divided by the third resistance circuit RES3 are supplied to the respective grayscale signal lines.

Thus, during the second period T2 after the first switching period TC1, the enable signal EN1 is set to be inactive and the enable signal EN2 is set to be active (and the enable signal EN3 is set to be inactive). Then, the respective plurality of grayscale voltages divided by the second resistance circuit RES2 are supplied to the respective grayscale signal lines. Then, an operation current is flowed into the operational amplifier OPⱼ and the output switch OSWⱼ is set to be in a conducting status and the bypass switch BSWⱼ is set to be in a non-conducting status. Then, the operational amplifier OPⱼ drives the output line OLⱼ based on a grayscale voltage selected from a plurality of grayscale voltages generated during the second period T2.

Then, during the second switching period TC2 including a timing at which the second period T2 is switched to the third period T3, the enable signal EN1 is set to be inactive and the enable signals EN2 and EN3 are set to be active. Then, the second the respective plurality of grayscale voltages divided by the resistance circuit RES2 are supplied to the respective grayscale signal lines and the second the respective plurality of grayscale voltages divided by the third resistance circuit RES3 are supplied to the respective grayscale signal lines.

The structure as described above can avoid, even in the case of the same grayscale voltage or different voltage levels, a situation where, when the second period T2 is switched to the third period T3, the potential of the grayscale signal line is closer to the potential of the switched period due to the capacity coupling, thus stabilizing the potential of the grayscale signal line.

In the third period T3 after the second switching period TC2, an output of the operational amplifier OPⱼ is set to be in a high impedance status and the enable signals EN1 and EN2 are set to be inactive and the enable signal EN3 is set to be active. Then, the respective plurality of grayscale voltages divided by the third resistance circuit RES3 are supplied to the respective grayscale signal lines. During this, an operation current of the operational amplifier OPⱼ is stopped or limited to set the output switch OSWⱼ to be in a non-conducting status and to set the bypass switch BSWⱼ to be in a conducting status. Then, a grayscale voltage selected from a plurality of grayscale voltages generated during the third period T3 is supplied to the output line OLⱼ.

Although the above embodiment has described an example of a polarity reversal driving, the invention is not limited to this. For example, the invention also can provide the same effect in a multiplex driving by the time sharing depending on the respective pieces of grayscale data for R, G, and B color components.

6. Electronic Device

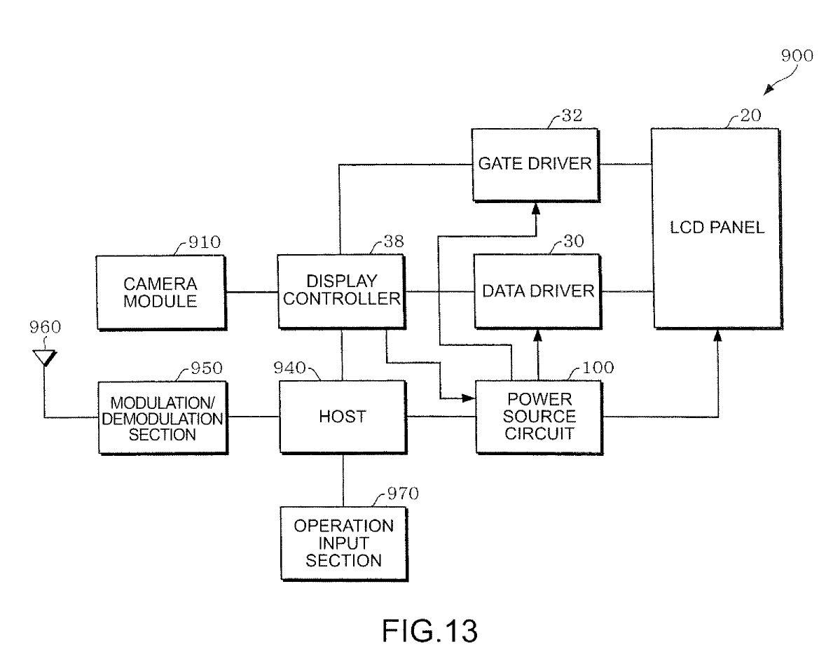

FIG. 13 is a block diagram illustrating an example of the structure of an electronic device in this embodiment. FIG. 13 shows the structure of a cellular telephone as an example of the structure of the electronic device. In FIG. 13, the same components as those of FIG. 1 or FIG. 2 are denoted with the same reference numerals and will not be described further.

A cellular telephone 900 includes a camera module 910. The camera module 910 includes a CCD camera and supplies, to the display controller 38, grayscale data of a YUV format of an image imaged by the CCD camera.

The cellular telephone 900 includes a LCD panel 20. The LCD panel 20 is driven by the data driver 30 and the gate driver 32. The LCD panel 20 includes a plurality of scanning lines, a plurality of data lines, and a plurality of pixels.

The display controller 38 is connected to the data driver 30 and the gate driver 32 and supplies RGB-formatted grayscale data to the data driver 30.

The power source circuit 100 is connected to the data driver 30 and the gate driver 32 and supplies a power source voltage for a driving to the respective drivers. An opposing electrode of the LCD panel 20 is supplied with an opposing electrode voltage Vcom.

A host 940 is connected to the display controller 38. The host 940 controls the display controller 38. After grayscale data received via an antenna 960 is demodulated by a modulation/demodulation section 950, the host 940 also can supply the data to the display controller 38. Based on this grayscale data, the display controller 38 allows the data driver 30 and the gate driver 32 to display the data on the LCD panel 20.

The grayscale data generated by the camera module 910 is demodulated by the modulation/demodulation section 950. Thereafter, the host 940 can instruct, via the apparatus to antenna 960, the transmission of the data to another communication apparatus.

Based on the operation information from an operation input section 970, the host 940 performs a processing for sending or receiving the grayscale data, a processing for an imaging by the camera module 910, and a processing for a display by the LCD panel 20.

It is noted that the invention is not limited to the above-described embodiments and various modifications can be made in the embodiments within a range of the summary of the invention. For example, the invention is not limited to the above-described driving of a liquid crystal display panel and also can be used for the driving of an electroluminescence or plasma display.

An invention according to a dependent claim in the invention also can use a structure in which requirements of a claim on which the dependent claim depends are partially omitted. The main part of an invention according to an independent claim of the invention also can depend on another independent claim.

What is claimed is:

1. A driving circuit that drives a data line of an electro-optic device, comprising:
a plurality of grayscale signal lines supplied with grayscale voltages, respectively;
a voltage-selecting circuit that selects one grayscale voltage from the plurality of grayscale voltages supplied to the plurality of grayscale signal lines;
an operational amplifier that drives, based on the grayscale voltage selected by the voltage-selecting circuit, an output line connected to the data line; and
first and second resistance circuits that generate a plurality of grayscale voltages obtained by dividing a voltage between a high potential-side power source and a low potential-side power source,
wherein:
the first resistance circuit has a total resistance value smaller than a total resistance value of the second resistance circuit,
each of the plurality of grayscale voltages divided by the first resistance circuit is supplied, during a first period, to each of the grayscale signal lines, and
each of the plurality of grayscale voltages divided by the second resistance circuit is supplied, during a second period after the first period, to each of the grayscale signal lines and the operational amplifier drives the output line based on the grayscale voltage selected from the plurality of grayscale voltages.

2. The driving circuit according to claim 1, wherein:
during the first switching period including a timing at which the first period is switched to the second period, each of the plurality of grayscale voltages divided by the first resistance circuit is supplied to each of the grayscale signal lines and the plurality of grayscale voltages divided by the second resistance circuit is supplied to each of the grayscale signal lines.

3. The driving circuit according to claim 1, further comprising a third resistance circuit that generates a plurality of grayscale voltages obtained by dividing a voltage between the high potential-side power source and the low potential-side power source, wherein
an output of the operational amplifier is set to be in a high impedance status during a third period after the second period and each of the plurality of grayscale voltages divided by the third resistance circuit is supplied to each of the grayscale signal lines and the grayscale voltage selected from the plurality of grayscale voltages is supplied to the output line.

4. The driving circuit according to claim 3, wherein:
the third resistance circuit has a total resistance value that is larger than a total resistance value of the first resistance circuit and that is smaller than a total resistance value of the second resistance circuit.

5. The driving circuit according to claim 3, wherein:
an operation current of the operational amplifier is stopped or limited during the third period.

6. The driving circuit according to claim 3, wherein:
during the second switching period including a timing at which the second period is switched to the third period, each of the plurality of grayscale voltages divided by the second resistance circuit is supplied to each of the grayscale signal lines and each of the plurality of grayscale voltages divided by the third resistance circuit is supplied to each of the grayscale signal lines.

7. The driving circuit according to claim 1, wherein:
at least one of the first resistance circuit and the third resistance circuit includes:
a high potential side resistance value-adjusting resistance circuit, connected to the high potential-side power source, having a plurality of divided-nodes that output a voltage obtained by dividing voltages at both ends;
a low potential side resistance value-adjusting resistance circuit, connected to the low potential-side power source, having a plurality of divided-nodes that output a voltage obtained by dividing voltages at both ends; and
a plurality of grayscale step-adjusting resistance circuits serially connected between one divided-node of the high potential side resistance value-adjusting resistance circuit and one divided node of the low potential side resistance value-adjusting resistance circuit, wherein
each of the plurality of grayscale step-adjusting resistance circuits has a plurality of grayscale voltage output nodes from which voltages obtained by dividing voltages at both ends by a variable resistance are output, and
voltage from each of the plurality of grayscale voltage output nodes is output as the grayscale voltage.

8. An electro-optic device, comprising:
a plurality of scanning lines;
a plurality of data lines;
a plurality of pixels;
a scanning line driving circuit that scans the plurality of scanning lines; and
the driving circuit according to claims 1 that drives the plurality of data lines.

9. An electronic device comprising the electro-optic device according to claim 8.
